(19) United States
(12) Patent Application Publication
(10) Pub. No.: US 2013/0050445 A1
(43) Pub. Date: Feb. 28, 2013

(54) VIDEO PROCESSING APPARATUS AND VIDEO PROCESSING METHOD

(71) Applicants: Tatsuya Miyake, Kawasaki-shi (JP); Hiroshi Fujimoto, Kawasaki-shi (JP); Tatsuhiro Nishioka, Kawasaki-shi (JP); Nobuyuki Ikeda, Tokyo (JP); Toshihiro Morohosi, Kawasaki-shi (JP)

(72) Inventors: Tatsuya Miyake, Kawasaki-shi (JP); Hiroshi Fujimoto, Kawasaki-shi (JP); Tatsuhiro Nishioka, Kawasaki-shi (JP); Nobuyuki Ikeda, Tokyo (JP); Toshihiro Morohosi, Kawasaki-shi (JP)

(73) Assignee: KABUSHIKI KAISHA TOSHIBA, Tokyo (JP)

(21) Appl. No.: 13/406,285

(22) Filed: Feb. 27, 2012

(30) Foreign Application Priority Data
Aug. 31, 2011 (JP) 2011-189548

(51) Int. Cl. H04N 13/04

(52) U.S. Cl. 348/51; 348/E13.075

(57) ABSTRACT

According to one embodiment, a video processing apparatus includes a viewer detector that performs face recognition using video photographed by a camera and acquires position information of viewers, a viewer selector that gives priority levels to the viewers on the basis of a predetermined prioritization rule and selects a predetermined number of viewers out of the viewers in order from a viewer having the highest priority level, a viewing area information calculator that calculates, using position information of the selected viewers, a control parameter for setting a viewing area in which the selected viewers are set, a viewing area controller that controls the viewing area according to the control parameter, a display that displays plural parallax images that the viewers present in the viewing area can observe as a stereoscopic video, and an apertural area controller that outputs the plural parallax images displayed on the display in a predetermined direction.

### CROSS-REFERENCE TO RELATED APPLICATIONS

This application is based upon and claims the benefit of priority from the prior Japanese Patent Application No. 2011-189548, filed on Aug. 31, 2011; the entire contents of which are incorporated herein by reference.

### FIELD

Embodiments described herein relate generally to a video processing apparatus and a video processing method.

### BACKGROUND

In recent years, a stereoscopic video display apparatus (a so-called autostereoscopic 3D television) that enables a viewer to see a stereoscopic video with naked eyes without using special glasses is becoming widely used. The stereoscopic video display apparatus displays plural images from different viewpoints. Rays of the images are guided to both eyes of the viewer with an output direction thereof controlled by, for example, a parallax barrier or a lenticular lens. If the position of the viewer is appropriate, since the viewer sees different parallax images with his left eye and his right eye, the viewer can stereoscopically recognize a video. An area where the viewer can see a stereoscopic video is referred to as a viewing area.

The viewing area is a limited area. When the viewer is outside the viewing area, the viewer cannot see the stereoscopic video. Therefore, the stereoscopic video display apparatus has a function of detecting the position of the viewer and controlling the viewing area to include the viewer in the viewing area (a face tracking function).

However, when plural viewers are present, all the viewers are not always set in the viewing area. On the other hand, among the viewers, some viewers should be preferentially set in the viewing area and others do not need to be preferentially set in the viewing area. For example, a person simply passing by in front of the stereoscopic video display apparatus does not need to be preferentially set in the viewing area.

### BRIEF DESCRIPTION OF THE DRAWINGS

FIG. 1 is an external view of a video processing apparatus 100 according to an embodiment;

FIG. 2 is a block diagram showing a schematic configuration of the video processing apparatus 100 according to the embodiment;

FIG. 3 is a diagram of a part of a liquid crystal panel 1 and a lenticular lens 2 viewed from above;

FIG. 4 is a top view showing an example of plural viewing areas 21 in a view area P of the video processing apparatus;

FIG. 5 is a block diagram showing a schematic configuration of a video processing apparatus 100′ according to a modification;

FIG. 6 is a flowchart for explaining a video processing method according to one embodiment;

FIG. 7 is a top view showing a viewing area set by the video processing method according to one embodiment; and

FIG. 8 is a diagram for explaining prioritization of viewers according to a prioritization rule.

### DETAILED DESCRIPTION

According to one embodiment, a video processing apparatus includes a viewer detector that performs face recognition using a video photographed by a camera and acquires position information of a viewer, a viewer selector that gives, when a plurality of the viewers are present, priority levels to the plural viewers on the basis of a predetermined prioritization rule and selects a predetermined number of viewers out of the plural viewers in order from a viewer having the highest priority level, a viewing area information calculator that calculates, using position information of the selected viewers, a control parameter for setting a viewing area in which the selected viewers are set, a viewing area controller that controls the viewing area according to the control parameter, a display that displays plural parallax images that the viewers present in the viewing area can observe as a stereoscopic video, and an apertural area controller that outputs the plural parallax images displayed on the display in a predetermined direction.

Embodiments will now be explained with reference to the accompanying drawings.

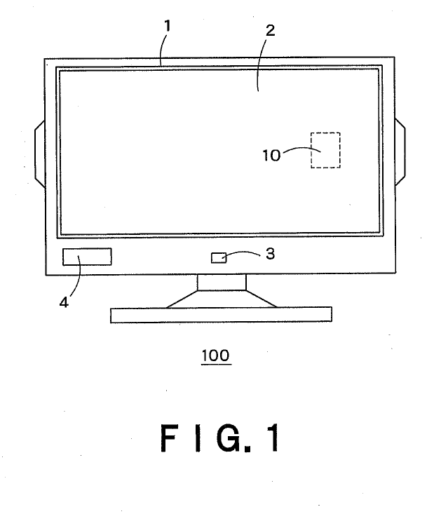

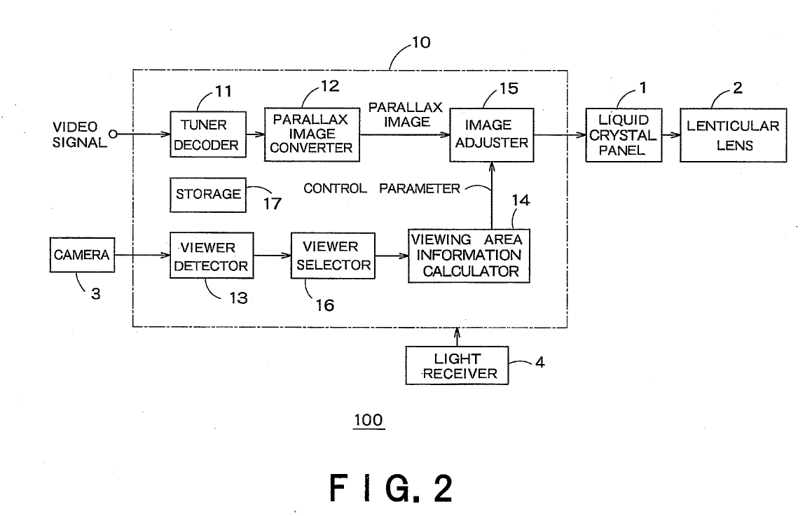

FIG. 1 is an external view of a video display apparatus 100 according to an embodiment. FIG. 2 is a block diagram showing a schematic configuration of the video display apparatus 100. The video display apparatus 100 includes a liquid crystal panel 1, a lenticular lens 2, a camera 3, a light receiver 4, and a controller 10.

The liquid crystal panel (a display) 1 displays plural parallax images that a viewer present in a viewing area can observe as a stereoscopic video. The liquid crystal panel 1 is, for example a 55-inch size panel. 11520 (=1280*9) pixels are arranged in the horizontal direction and 720 pixels are arranged in the vertical direction. In each of the pixels, three sub-pixels, i.e., an R sub-pixel, a G sub-pixel, and a B sub-pixel are formed in the vertical direction. Light is irradiated on the liquid crystal panel 1 from a backlight device (not shown) provided in the back. The pixels transmit light having luminance corresponding to a parallax image signal (explained later) supplied from the controller 10.

The lenticular lens (an apertural area controller) 2 outputs the plural parallax images displayed on the liquid crystal panel 1 (the display) in a predetermined direction. The lenticular lens 2 includes plural convex portions arranged along the horizontal direction of the liquid crystal panel 1. The number of the convex portions is 1/9 of the number of pixels in the horizontal direction of the liquid crystal panel 1. The lenticular lens 2 is stuck to the surface of the liquid crystal panel 1 such that one convex portion corresponds to nine pixels arranged in the horizontal direction. The light transmitted through the pixels is output, with directivity, in a specific direction from near the vertex of the convex portion.

The liquid crystal panel 1 according to this embodiment can display a stereoscopic video in an integral imaging manner of three or more parallaxes or a stereo imaging manner. Besides, the liquid crystal panel 1 can also display a normal two-dimensional video.

In the following explanation, an example in which nine pixels are provided to correspond to the convex portions of the liquid crystal panel 1 and an integral imaging manner of nine parallaxes can be adopted is explained. In the integral imaging manner, first to ninth parallax images are respectively displayed on the nine pixels corresponding to the convex portions. The first to ninth parallax images are images of a subject seen respectively from nine viewpoints arranged along the horizontal direction of the liquid crystal panel 1. The viewer can stereoscopically view a video by seeing one parallax image among the first to ninth parallax images with his left eye and seeing another one parallax image with his right eye. According to the integral imaging manner, a viewing area can be expanded as the number of parallaxes is increased. The viewing area means an area where a video can be stereoscopically viewed when the liquid crystal panel 1 is seen from the front of the liquid crystal panel 1.

On the other hand, in the stereo imaging manner, parallax images for the right eye are displayed on four pixels among the nine pixels corresponding to the convex portions and parallax images for the left eye are displayed on the other five pixels. The parallax images for the left eye and the right eye are images of the subject viewed respectively from a viewpoint on the left side and a viewpoint on the right side of two viewpoints arranged in the horizontal direction. The viewer can stereoscopically view a video by seeing the parallax images for the left eye with his left eye and seeing the parallax images for the right eye with his right eye through the lenticular lens 2. According to the stereo imaging manner, feeling of three-dimensionality of a displayed video is more easily obtained than the integral imaging manner. However, a viewing area is narrower than that in the integral imaging manner.

The liquid crystal panel 1 can also display the same image on the nine pixels corresponding to the convex portions and display a two-dimensional image.

In this embodiment, the viewing area can be variably controlled according to a relative positional relation between the convex portions of the lenticular lens 2 and displayed parallax images, i.e., what kind of parallax images are displayed on the nine pixels corresponding to the convex portions. The control of the viewing area is explained below taking the integral imaging manner as an example.

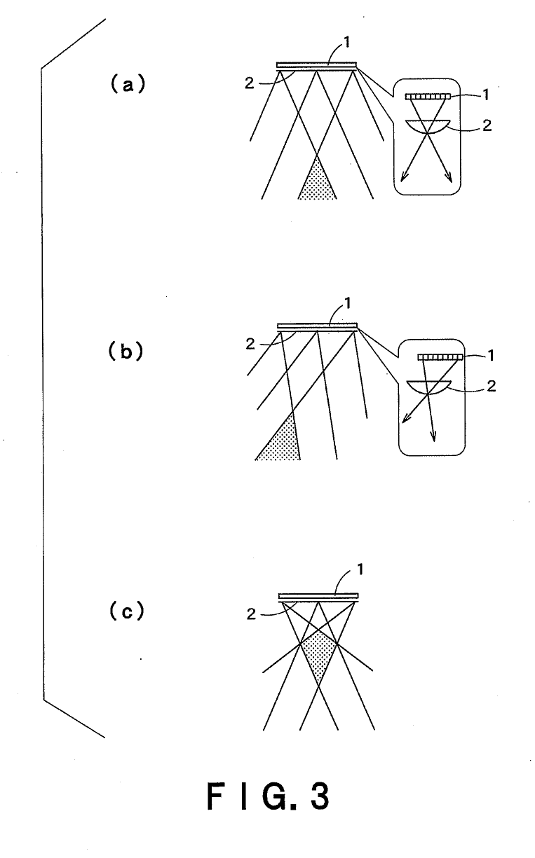

FIG. 3 is a diagram of a part of the liquid crystal panel 1 and the lenticular lens 2 viewed from above. A hatched area in the figure indicates the viewing area. The viewer can stereoscopically view a video when the viewer sees the liquid crystal panel 1 from the viewing area. Other areas are areas where a pseudoscopic image and crosstalk occur and areas where it is difficult to stereoscopically view a video.

FIG. 3 shows a relative positional relation between the liquid crystal panel 1 and the lenticular lens 2, more specifically, a state in which the viewing area changes according to a distance between the liquid crystal panel 1 and the lenticular lens 2 or a deviation amount in the horizontal direction between the liquid crystal panel 1 and the lenticular lens 2.

Actually, the lenticular lens 2 is stuck to the liquid crystal panel 1 while being highly accurately aligned with the liquid crystal panel 1. Therefore, it is difficult to physically change relative positions of the liquid crystal panel 1 and the lenticular lens 2.

Therefore, in this embodiment, display positions of the first to ninth parallax images displayed on the pixels of the liquid crystal panel 1 are shifted to apparently change a relative positional relation between the liquid crystal panel 1 and the lenticular lens 2 to thereby perform adjustment of the viewing area.

For example, compared with a case in which the first to ninth parallax images are respectively displayed on the nine pixels corresponding to the convex portions (FIG. 3(a)), when the parallax images are shifted to the right side as a whole and displayed (FIG. 3(b)), the viewing area moves to the left side. Conversely, when the parallax images are shifted to the left side as a whole and displayed, the viewing area moves to the right side.

When the parallax images are not shifted near the center in the horizontal direction and the parallax images are more largely shifted to the outer side and displayed further on the outer side of the liquid crystal panel 1 (FIG. 3(c)), the viewing area moves in a direction in which the viewing area approaches the liquid crystal panel 1. Further a pixel between a parallax image to be shifted and a parallax image not to be shifted and a pixel between parallax images having different shift amounts only have to be appropriately interpolated according to pixels around the pixels. Conversely to FIG. 3(c), when the parallax images are not shifted near the center in the horizontal direction and the parallax images are more largely shifted to the center side and displayed further on the outer side of the liquid crystal panel 1, the viewing area moves in a direction in which the viewing area is away from the liquid crystal panel 1.

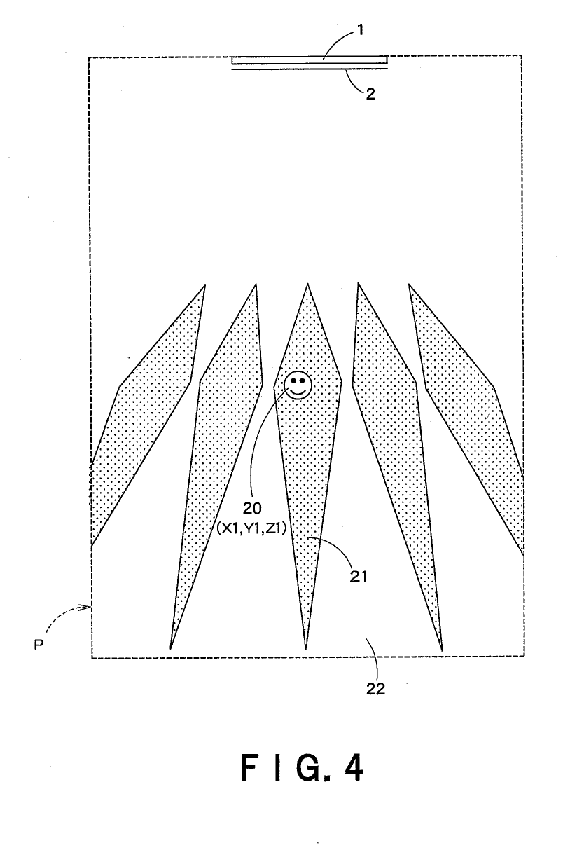

By shifting and displaying all or a part of the parallax images in this way, it is possible to move the viewing area in the left right direction or the front back direction with respect to the liquid crystal panel 1. In FIG. 3, only one viewing area is shown to simplify the explanation. However, actually, as shown in FIG. 4, plural viewing areas 21 are present in the view area P and move in association with one another. The viewing area is controlled by the controller 10 shown in FIG. 2 explained later. Further a view area other than the viewing areas 21 is a pseudoscopic image area 22 where it is difficult to see a satisfactory stereoscopic video because of occurrence of a pseudoscopic image, crosstalk, or the like.

Referring back to FIG. 1, the components of the video processing apparatus 100 are explained.

The camera 3 is attached near the center in a lower part of the liquid crystal panel 1 at a predetermined angle of elevation and photographs a predetermined range in the front of the liquid crystal panel 1. A photographed video is supplied to the controller 10 and used to detect information concerning the viewer such as the position, the face, and the like of the viewer. The camera 3 may photograph either a moving image or a still image.

The light receiver 4 is provided, for example, on the left side in a lower part of the liquid crystal panel 1. The light receiver 4 receives an infrared ray signal transmitted from a remote controller used by the viewer. The infrared ray signal includes a signal indicating, for example, whether a stereoscopic video is displayed or a two-dimensional video is displayed, which of the integral imaging manner and the stereo imaging manner is adopted when the stereoscopic video is displayed, and whether control of the viewing area is performed.

Next, details of the components of the controller 10 are explained. As shown in FIG. 2, the controller 10 includes a tuner decoder 11, a parallax image converter 12, a viewer detector 13, a viewing area information calculator 14, an image adjuster 15, a viewer selector 16, and a storage 17. The controller 10 is implemented as, for example, one IC (Integrated Circuit) and arranged on the rear side of the liquid crystal panel 1. It goes without saying that a part of the controller 10 is implemented as software.

The tuner decoder (a receiver) 11 receives and tunes an input broadcast wave and decodes an encoded video signal. When a signal of a data broadcast such as an electronic program guide (EPG) is superimposed on the broadcast wave, the tuner decoder 11 extracts the signal. Alternatively, the tuner decoder 11 receives, rather than the broadcast wave, an encoded video signal from a video output apparatus such as an optical disk player or a personal computer and decodes the video signal. The decoded signal is also referred to as baseband video signal and is supplied to the parallax image converter 12. Note that when the video display apparatus 100 does not receive a broadcast wave and solely displays a video signal received from the video output apparatus, a decoder simply having a decoding function may be provided as a receiver instead of the tuner decoder 11.

A video signal received by the tuner decoder 11 may be a two-dimensional video signal or may be a three-dimensional video signal including images for the left eye and the right eye in a frame packing (FP), side-by-side (SBS), or top-and-bottom (TAB) manner and the like. The video signal may be a three-dimensional video signal including images having three or more parallaxes.

In order to stereoscopically display a video, the parallax image converter 12 converts a baseband video signal into plural parallax image signals and supplies the parallax image signals to the image adjuster 15. Processing content of the parallax image converter 12 is different according to which of the integral imaging matter and the stereo imaging manner is adopted. The processing content of the parallax image converter 12 is different according to whether the baseband video signal is a two-dimensional video signal or a three-dimensional video signal.

When the stereo imaging manner is adopted, the parallax image converter 12 generates parallax image signals for the left eye and the right eye respectively corresponding to the parallax images for the left eye and the right eye. More specifically, the parallax image converter 12 generates the parallax image signals as explained below.

When the stereo imaging manner is adopted and a three-dimensional video signal including images for the left eye and the right eye is input, the parallax image converter 12 generates parallax image signals for the left eye and the right eye that can be displayed on the liquid crystal panel 1. When a three-dimensional video signal including three or more images is input, the parallax image converter 12 generates parallax image signals for the left eye and the right eye using, for example, arbitrary two of the three images.

In contrast, when the stereo imaging manner is adopted and a two-dimensional video signal not including parallax information is input, the parallax image converter 12 generates parallax image signals for the left eye and the right eye on the basis of depth values of pixels in the video signal. The depth value is a value indicating to which degree the pixels are displayed to be seen in the front or the depth with respect to the liquid crystal panel 1. The depth value may be added to the video signal in advance or may be generated by performing motion detection, composition identification, human face detection, and the like on the basis of characteristics of the video signal. In the parallax image for the left eye, a pixel seen in the front needs to be displayed to be shifted further to the right side than a pixel seen in the depth. Therefore, the parallax image converter 12 performs processing for shifting the pixel seen in the front in the video signal to the right side and generates a parallax image signal for the left eye. A shift amount is set larger as the depth value is larger.

On the other hand, when the integral imaging manner is adopted, the parallax image converter 12 generates first to ninth parallax image signals respectively corresponding to the first to ninth parallax images. More specifically, the parallax image converter 12 generates the first to ninth parallax image signals as explained below.

When the integral imaging manner is adopted and a two-dimensional video signal or a three-dimensional video signal including images having eight or less parallaxes is input, the parallax image converter 12 generates the first to ninth parallax image signals on the basis of depth information same as that for generating the parallax image signals for the left eye and the right eye from the two-dimensional video signal.

When the integral imaging manner is adopted and a three-dimensional video signal including images having nine parallaxes is input, the parallax image converter 12 generates the first to ninth parallax image signals using the video signal.

The viewer detector 13 performs face recognition using a video photographed by the camera 3 and acquires information concerning the viewer (e.g., face information and position information of the viewer; hereinafter generally referred to as “viewer recognition information”) and supplies the information to a viewer selector 16 explained later. The viewer detector 13 can track the viewer even if the viewer moves. Therefore, it is also possible to grasp a viewing time for each viewer.

The position information of the viewer is represented as, for example, a position on an X axis (in the horizontal direction), a Y axis (in the vertical direction), and a Z axis (a direction orthogonal to the liquid crystal panel 1) with the origin set in the center of the liquid crystal panel 1. The position of a viewer 20 shown in FIG. 4 is represented by a coordinate (X1, Y1, Z1). More specifically, first, the viewer detector 13 detects a face from a video photographed by the camera 3 to thereby recognize the viewer. Subsequently, the viewer detector 13 calculates a position (X1, Y1) on the X axis and the Y axis from the position of the viewer in the video and calculates a position (Z1) on the Z axis from the size of the face. When there are plural viewers, the viewer detector 13 may detect a predetermined number of viewers, for example, ten viewers. In this case, when the number of detected faces is larger than ten, for example, the viewer detector 13 detects positions of the ten viewers in order from a position closest to the liquid crystal panel 1, i.e., a smallest position on the Z axis.

The viewing area information calculator 14 calculates, using the position information of the viewer selected by the viewer selector 16 explained later, a control parameter for setting a viewing area in which the selected viewer is set. The control parameter is, for example, an amount for shifting the parallax images explained with reference to FIG. 3 and is one parameter or a combination of plural parameters. The viewing area information calculator 14 supplies the calculated control parameter to the image adjuster 15.

More specifically, in order to set a desired viewing area, the viewing area information calculator 14 uses a viewing area database that associates the control parameter and a viewing area set by the control parameter. The viewing area database is stored in the storage 17 in advance. The viewing area information calculator 14 finds, by searching through the viewing area database, a viewing area in which the selected viewer can be included.

When a viewer is not selected by the viewer selector 16, the viewing area information calculator 14 calculates control parameters for setting a viewing area in which as many viewers as possible are set.

In order to control the viewing area, after performing adjustment for shifting and interpolating a parallax image signal according to the calculated control parameter, the image adjuster (a viewing area controller) 15 supplies the parallax image signal to the liquid crystal panel 1. The liquid crystal panel 1 displays an image corresponding to the adjusted parallax image signal.

The viewer selector 16 gives, on the basis of a prioritization rule for prioritizing viewers, priority levels to viewers detected by the viewer detector 13. Thereafter, the viewer selector 16 selects a predetermined number of (one or plural) viewers out of the viewers in order from a viewer having the highest priority level and supplies position information of the selected viewers to the viewing area information calculator 14.

Note that the prioritization rule has been set in advance and a user may select a desired one out of plural prioritization rules on a menu screen or the like or a predetermined prioritization rule may be set when a product is shipped.

When the prioritization rule has not been set, the viewer selector 16 sends a viewer non-selection notification indicating that viewers are not selected to the viewing area information calculator 14.

The storage 17 is a nonvolatile memory such as a flash memory. Besides a viewing area database, the storage 17 stores user registration information, 3D priority viewer information, an initial viewing position, and the like explained later. The storage 17 may be provided on the outside of the controller 10.

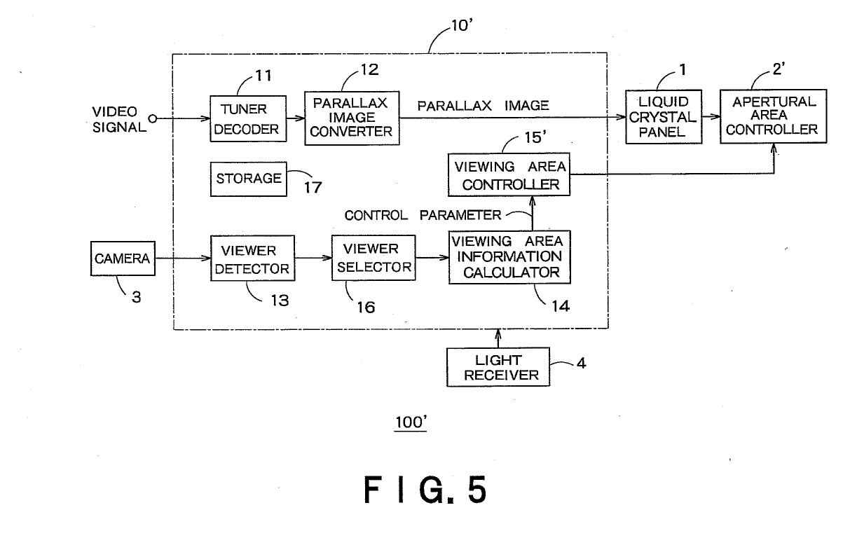

The configuration of the video processing apparatus 100 is explained above. In this embodiment, the example in which the lenticular lens 2 is used and the viewing area is controlled by shifting the parallax image is explained. However, the viewing area may be controlled by other methods. For example, a parallax barrier may be provided as an apertural area controller 2′ instead of the lenticular lens 2. FIG. 5 is a block diagram showing a schematic configuration of a video processing apparatus 100′ according to a modification of this embodiment shown in FIG. 2. As shown in the figure, a controller 10′ of the video processing apparatus 100′ includes a viewing area controller 15′ instead of the image adjuster 15. The viewing area controller 15′ controls an apertural area controller 2′ according to a control parameter calculated by the viewing area information calculator 14. In the case of this modification, the control parameter is a distance between the liquid crystal panel 1 and the apertural area controller 2′, a deviation amount in the horizontal direction between the liquid crystal panel 1 and the apertural area controller 2′, and the like.

In this modification, an output direction of a parallax image displayed on the liquid crystal panel 1 is controlled by the apertural area controller 2′, whereby the viewing area is controlled. In this way, the apertural area controller 2′ may be controlled by the viewing area controller 15′ without performing processing for shifting the parallax image.

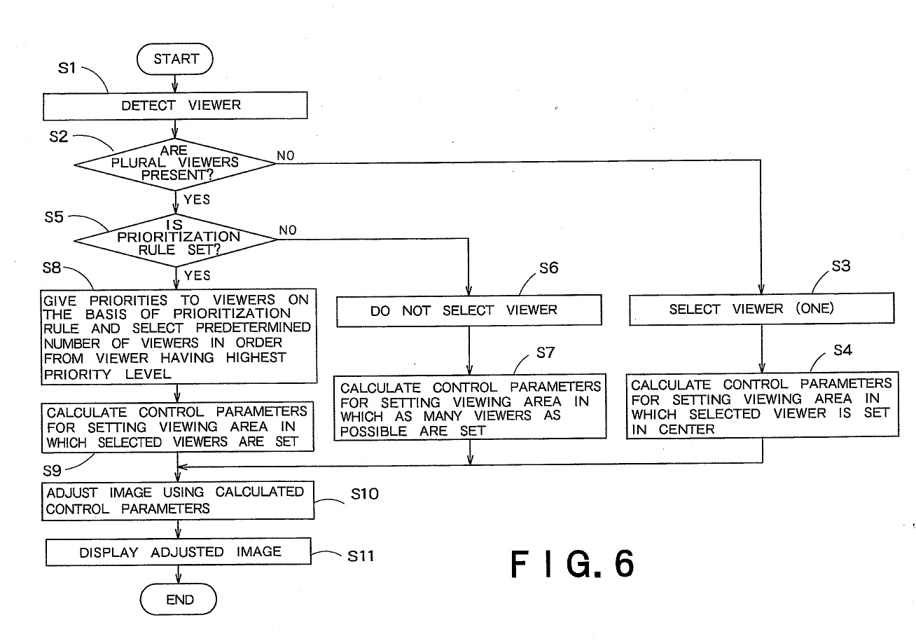

Next, a video processing method by the video processing apparatus 100 (100′) configured as explained above is explained with reference to the flowchart of FIG. 6.

(1) The viewer detector 13 performs face recognition using a video photographed by the camera 3 and acquires viewer recognition information (step S1).

(2) The viewer detector 13 determines whether plural viewers are present (step S2). If one viewer is present as a result of the determination, the viewer detector 13 supplies viewer recognition information of the viewer to the viewer selector 16. On the other hand, if plural viewers are present, the viewer detector 13 supplies all kinds of viewer recognition information of the detected plural viewers to the viewer selector 16.

(3) When position information of only one viewer is supplied from the viewer detector 13, the viewer selector 16 selects the viewer (one) and supplies viewer recognition information of the viewer to the viewing area information calculator 14 (step S3).

(4) The viewing area information calculator 14 calculates control parameters for setting a viewing area in which the selected viewer (one) is set in a position where a highest-quality stereoscopic video can be seen (e.g., the center of the viewing area; the same applies below) (step S4).

(5) When plural viewers are present, the viewer selector 16 determines whether a prioritization rule for giving priority levels to the viewers is set (step S5).

(6) When prioritization rule is not set, the viewer selector 16 notifies the viewing area information calculator 14 that a viewer is not selected (step S6).

(7) The viewing area information calculator 14 calculates control parameters for setting a viewing area in which as many viewers as possible are set (step S7).

(8) The viewer selector 16 gives priority levels to the viewers on the basis of the prioritization rule, selects a predetermined number of viewers out of the viewers in order from a viewer having the highest priority level, and supplies viewer recognition information (position information) of the selected viewers to the viewing area information calculator 14 (step S8).

Concerning a specific method of giving priority levels to the detected viewers, for example, in the case of the prioritization rule for prioritizing a viewer present in a front direction of the liquid crystal panel 1, the viewer selector 16 gives, using the position information of the viewers supplied from the viewer detector 13, priority levels to the viewers in order from the viewer present in the front direction of the liquid crystal panel 1 to a viewer present in an oblique direction. Thereafter, the viewer selector 16 selects a predetermined number of (one or plural) viewers in order from a viewer having the highest priority level. Besides the prioritization rule, various prioritization rules are assumed. Other specific examples are collectively explained later.

(9) The viewing area information calculator 14 calculates control parameters for setting a viewing area in which the selected viewers are set (step S9).

When not all the selected viewers can be set in the viewing area (i.e., a viewing area in which all the selected viewers are set cannot be found), the viewing area information calculator 14 calculates control parameters for setting a viewing area in which as many selected viewers as possible are set in order from the viewer having the highest priority level. For example, first, the viewing area information calculator 14 excludes a viewer having the lowest priority level among the selected viewers and attempts to calculate control parameters for setting a viewing area in which all the remaining viewers are set. When control parameters still cannot be calculated, the viewing area information calculator 14 excludes a viewer having the lowest priority level among the remaining viewers and attempts to calculate control parameters. By repeating this processing, it is possible to always set viewers having high priority levels in the viewing area.

The viewing area information calculator 14 may calculate control parameters for setting, irrespective of whether all the selected viewers are set in a viewing area, a viewing area in which the viewer having the highest priority level among the selected viewers is set in a position where a highest-quality stereoscopic video can be seen.

When the number of views selected by the viewer selector 16 is one, the viewing area information calculator 14 may calculate control parameters for setting a viewing area in which the viewer is set in a position where a highest-quality stereoscopic video can be seen.

(10) The image adjuster 15 adjusts an image (a parallax image signal) using the control parameters calculated in step S4, S7, or S9 and supplies the image to the liquid crystal panel 1 (step S10).

In the case of the video processing apparatus 100′ according to the modification, the viewing area controller 15′ controls the apertural area controller 2′ using the control parameters calculated in step S4, S7, or S9.

(11) The liquid crystal panel 1 displays the image adjusted by the image adjuster 15 in step S10 (step S11).

In the case of the video processing apparatus 100′ according to the modification, the liquid crystal panel 1 displays the image supplied from the parallax image converter 12.

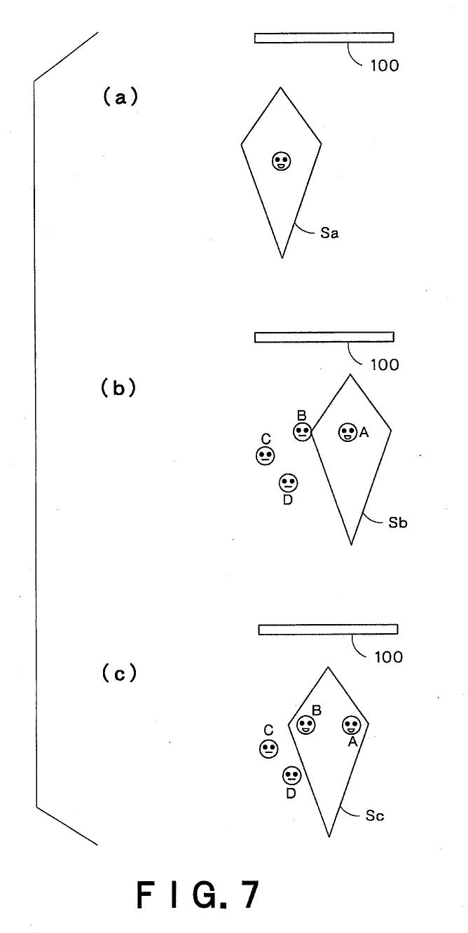

Next, the setting of a viewing area by the video processing method is specifically explained with reference to FIG. 7.

FIGS. 7(a), 7(b), and 7(c) show the video processing apparatus 100 (100′), viewers (four), and set viewing areas (Sa, Sb, and Sc). Among the figures, the number and the positions of viewers are the same. Letters affixed to the viewers indicate priority levels. The priority levels are high in order of A, B, C, and D.

FIG. 7(a) shows an example of the viewing area set through steps S6 and S7. As shown in the figure, three viewers are present in the viewing area Sa. In this case, since a prioritization rule is not set, priority levels of the viewers are not taken into account and a viewing area is set to maximize the number of viewers set in the viewing area.

FIGS. 7(b) and 7(c) show the viewing area set through steps S8 and S9. In FIG. 7(b), although the number of viewers set in the viewing area decreases compared with FIG. 7(a), two viewers having high priority levels are present in the viewing area Sb. In FIG. 7(c), although the number of viewers set in the viewing area further decreases compared with FIG. 7(b), the viewing area Sc is set such that the viewer having the highest priority level is located in the center of the viewing area.

Next, specific examples (a) to (h) of the prioritization rule are listed below.

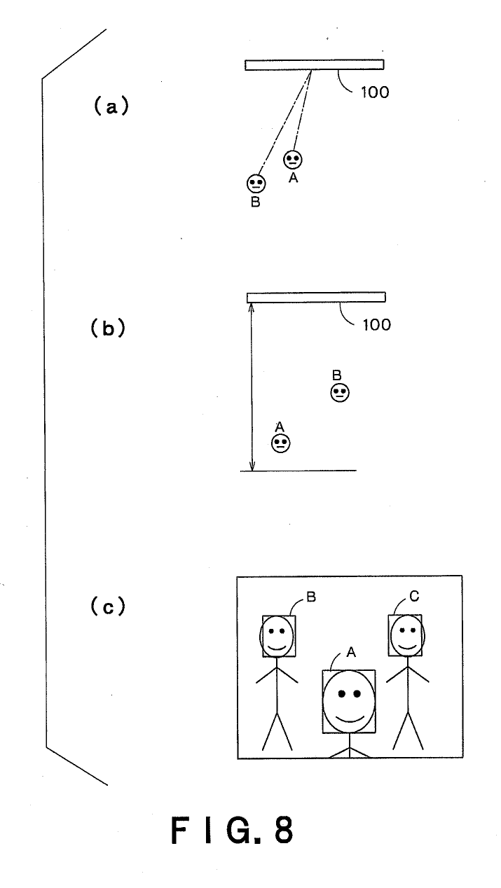

(a) A viewer present in the front of the liquid crystal panel 1 is more likely to have a higher viewing desire than a viewer present at an end of the liquid crystal panel 1. Therefore, in this prioritization rule, as shown in FIG. 8(a), high priority levels are given in order from the viewer present in the front direction of the liquid crystal panel 1 to the viewer present at the end of the liquid crystal panel 1.

When this prioritization rule is adopted, the viewer selector 16 calculates, using, for example, position information of the viewers, an angle (maximum 90°) formed by a display surface of the liquid crystal panel 1 and a surface in the vertical direction passing through the center of the viewers and the liquid crystal panel 1 and gives high priority levels in order from a viewer having the largest angle.

(b) A viewer close to a viewing distance (a distance between the liquid crystal panel 1 and the viewer) optimum in viewing a stereoscopic video is prioritized. In this prioritization rule, as shown in FIG. 8(b), high priority levels are given in order from a viewer whose viewing distance is closest to a viewing distance optimum in viewing a stereoscopic video (an optimum viewing distance “d”). Since a value of the optimum viewing distance “d” depends on various parameters such as the size of the liquid crystal panel, a different value is set for each product of the video processing apparatus.

When this prioritization rule is adopted, the viewer selector 16 calculates a difference between a position on the Z axis included in position information of viewers and the optimum viewing distance “d” and gives high priority levels in order from a viewer having the smallest difference.

(c) A viewer having a longer viewing time is more likely to have a higher viewing desire for a program that the viewer views. Therefore, in this prioritization rule, high priority levels are given in order from a viewer having the longest viewing time. The viewing time is calculated with reference to, for example, a start time of a program that the viewer is viewing. The start time of the program that the viewer is viewing can be acquired from an electronic program guide (EPG) or the like. The viewing time may be calculated with reference to time when the program that the viewer is viewing is tuned. The viewing time may be calculated with reference to time when a power supply for the video display apparatus 100 is turned on and video display is started.

When this prioritization rule is adopted, the viewer selector 16 calculates a viewing time for each viewer and gives high priority levels in order from a viewer having the longest viewing time.

(d) Since a viewer having a remote controller selects a viewing channel by operating the remote controller, the viewer is more likely to be a central viewer. Therefore, in this prioritization rule, the highest priority level is given to the viewer having the remote controller or a viewer closest to the remote controller.

When this prioritization rule is adopted, the viewer detector 13 recognizes the viewer having the remote controller and supplies viewer recognition information of the viewer to the viewer selector 16. As a method of recognizing the viewer having the remote controller, there are, for example, a method of detecting, with the camera 3, an infrared ray emitted from the remote controller or a mark provided in the remote controller in advance and recognizing a viewer closest to a remote controller position and a method of directly recognizing the viewer having the remote controller through image recognition. The viewer selector 16 then gives the highest priority level to the viewer having the remote controller. Concerning viewers other than the viewer having the remote controller, the viewer selector 16 may, for example, give high priority levels in order from a viewer closest to the remote controller.

(e) It is also possible to cause the storage 17 to store, as user registration information, information concerning the user of the video processing apparatus 100. The user registration information can include, besides a name and a face photograph, information such as an age, height, and a 3D viewing priority level indicating a priority level for viewing a stereoscopic video. In this prioritization rule, a viewer having a high 3D viewing priority level is prioritized.

When this prioritization rule is adopted, the viewer detector 13 acquires face information of viewers from a video photographed by the camera 3. The viewer detector 13 retrieves, concerning each of the viewers, a face photograph of the user registration information matching the face information to thereby read out a 3D viewing priority level of the viewer from the storage 17. The viewer detector 13 supplies, concerning the viewers, information in which position information and 3D viewing priority levels are combined to the viewer selector 16. The viewer selector 16 gives, on the basis of the information supplied from the viewer detector 13, high priority levels in order from a viewer having the highest 3D viewing priority level. Further, a lower (or lowest) priority level may be given to a viewer whose user registration information is absent.

(f) The video display apparatus 100 has a function of displaying a video photographed by the camera 3 (hereinafter referred to as “camera video”) on the liquid crystal panel 1. As shown in FIG. 8(c), in the camera video, a frame pattern is added to a face of a recognized viewer and a specific viewer can be selected. In this prioritization rule, a high priority level is given to a viewer selected on the camera video.

More specifically, the user selects one viewer on the camera video. Consequently, face information of the selected viewer is stored in the storage 17 as 3D priority viewer information. The selection of a viewer can be changed on the camera video. If a viewer matching the face information of the 3D priority viewer information stored in the storage 17 is present, the viewer selector 16 gives the highest priority level to the viewer.

As shown in FIG. 8(c), it is also possible to select plural viewers on the camera video with priority ranks given to the viewers. In this case, the viewer selector 16 gives priority levels to the viewers according to the priority ranks given on the camera video. In this way, priority levels are given to the viewers on the basis of the 3D priority viewer information.

(g) Depending on an arrangement state of the video processing apparatus 100 and furniture such as a sofa and a chair, it is assumed that a viewer views a video from an oblique direction rather than from the front of the liquid crystal panel 1. In such a case, a frequency of setting a viewing area in an oblique direction of the liquid crystal panel 1 increases. Therefore, in this prioritization rule, a viewer present in a place where the viewing area is frequently set is prioritized.

When this prioritization rule is adopted, for example, every time the viewing area information calculator 14 calculates control parameters, the viewing area information calculator 14 stores the calculated control parameters in the storage 17. The viewer selector 16 specifies, from the control parameters stored in the storage 17, a viewing area with a large number of times set and gives a higher priority level to a viewer present in the viewing area than a viewer present outside the viewing area.

(h) The user of the video processing apparatus 100 can also set, as an initial viewing position, for example, a position where the user can most easily view a video. In this prioritization rule, the user sets the initial viewing position in advance. A viewer present in the initial viewing position is prioritized.

When this prioritization rule is adopted, the storage 17 stores information concerning the initial viewing position set by the user. The viewer selector 16 reads out the set initial viewing position from the storage 17 and gives a high priority level to a viewer present in the viewing position.

As explained above, according to the video processing apparatus and the video processing method according to this embodiment, even when plural viewers are present and a part of the viewers are not set in a viewing area, a viewer having a high priority level is always set in the viewing area. Therefore, the viewer having the high priority level can view a high-quality stereoscopic video.

Further, in this embodiment, when a prioritization rule is set, a viewing area is controlled to set a viewer having a high priority level in the viewing area. Therefore, as a result, it is possible to improve performance of face tracking. In other words, for example, when, although no viewer is present, the viewer detector erroneously detects a viewer, a viewing area is adjusted to such a viewer in normal face tracking. On the other hand, according to this embodiment, if, for example, a prioritization rule for prioritizing a viewer having a high 3D viewing priority level of user registration information or a viewer selected on a camera video is adopted, it is possible to neglect the viewer described above and appropriately perform the adjustment of the viewing area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A video processing apparatus comprising:
a viewer detector configured to perform face recognition using a video obtained by a camera and configured to acquire position information of one or more viewers;
a viewer selector configured to give, when a plurality of viewers are present, priority levels to the viewers based on a prioritization rule and configured to select a number of viewers based on priority level;
a viewing area information calculator configured to calculate, using position information of the selected viewers, a control parameter for setting a viewing area;
a viewing area controller configured to control the viewing area according to the control parameter;
a display configured to display parallax images configured to be observed as a stereoscopic video; and
an apertural area controller configured to output the plural parallax images displayed on the display in a direction.

2. The video processing apparatus of claim 1, wherein, when not all the selected viewers can be set in the viewing area, the viewing area information calculator is configured to calculate a control parameter for setting a viewing area in which as many of the selected viewers as possible are set in order from a viewer having a highest priority level.

3. The video processing apparatus of claim 1, wherein the viewing information calculator is configured to calculate a control parameter for setting a viewing area in which a viewer given a highest priority level among the selected viewers is set in a position where a highest-quality stereoscopic video can be seen.

4. The video processing apparatus of claim 1, wherein:
when the prioritization rule is not set, the viewer selector is configured to send a viewer non-selection notification indicating that viewers are not selected to the viewing area information calculator, and
when the viewing area information calculator receives the viewer non-selection notification, the viewing area information calculator is configured to calculate a control parameter for setting a viewing area in which as many of the viewers as possible are set.

5. The video processing apparatus of claim 1, wherein, when a number of viewers detected by the viewer detector or a number of viewers selected by the viewer selector is one, the viewing area information calculator is configured to calculate a control parameter for setting a viewing area where a highest-quality stereoscopic video can be seen.

6. The video processing apparatus of claim 1, wherein the viewer selector is configured to give high priority levels in order from a viewer present in a front of the display to a viewer present at an end of the display.

7. The video processing apparatus of claim 1, wherein the viewer selector is configured to give high priority levels in order from a viewer whose viewing distance, a distance between the display and the viewer, is closest to a viewing distance optimum for viewing a stereoscopic video.

8. The video processing apparatus of claim 1, wherein the viewer selector is configured to give high priority levels in order from a viewer having a longest viewing time.

9. The video processing apparatus of claim 1, wherein the viewer selector is configured to give a highest priority level to a viewer having a remote controller or a viewer closest to the remote controller.

10. The video processing apparatus of claim 1, further comprising a storage configured to store user registration information comprising a face photograph and a 3D viewing priority level of a user, wherein:
the viewer detector is configured to acquire respective kinds of face information of the viewers from a video photographed by the camera and is configured to retrieve, for each of the viewers, a face photograph of the user registration information matching the face information to thereby read out the 3D viewing priority level of the viewer from the storage, and
the viewer selector is configured to give high priority levels in order from a viewer having the highest 3D viewing priority level.

11. The video processing apparatus of claim 1, further comprising a storage that is configured to store, as 3D priority viewer information, face information of a viewer selected on a camera video, wherein
the viewer selector is configured to give priority levels to the plural viewers on the basis of the 3D priority viewer information stored in the storage.

12. The video processing apparatus of claim 1, further comprising a storage that is configured to store the control parameter calculated by the viewing area information calculator, wherein
the viewer selector is configured to specify, from the control parameter stored in the storage, a viewing area with a large number of times set and configured to give a higher priority level to a viewer present in the viewing area than a viewer present outside the viewing area.

13. The video processing apparatus of claim 1, further comprising a storage that is configured to store information concerning an initial viewing position set by a user, wherein
the viewer selector is configured to read out the initial viewing position from the storage and is configured to give a high priority level to a viewer present in the viewing position.

14. The video processing apparatus of claim 1, wherein the viewing area controller is configured to adjust, according to the control parameter, display positions of the plural parallax images displayed on the display or is configured to control, according to the control parameter, an output direction of the plural parallax images displayed on the display.

15. A video processing method comprising:
performing face recognition using a video obtained by a camera and acquiring position information of one or more viewers;
giving, when a plurality of viewers are present, priority levels to the viewers based on a prioritization rule and selecting a number of viewers based on priority level;
calculating, using position information of the selected viewers, a control parameter for setting a viewing area; and
controlling the viewing area according to the control parameter.

16. The video processing method of claim 15, further comprising calculating, when not all the selected viewers can be set in the viewing area, a control parameter for setting a viewing area in which as many of the selected viewers as possible are set in order from a viewer having a highest priority level.

17. The video processing method of claim 15, further comprising calculating a control parameter for setting a viewing area in which a viewer given a highest priority level among the selected viewers is set in a position where a highest-quality stereoscopic video can be seen.

18. The video processing method of claim 15, further comprising calculating, when the prioritization rule is not set, a control parameter for setting a viewing area in which as many of the plural viewers as possible are set.

19. The video processing method of claim 15, further comprising:
storing user registration information comprising a face photograph and a 3D viewing priority level of a user;
acquiring respective kinds of face information of the viewers from a video photographed by the camera and retrieving, for each of the viewers, a face photograph of the user registration information matching the face information to thereby read out the 3D viewing priority level of the viewer from the storage; and
giving high priority levels in order from a viewer having the highest 3D viewing priority level.

20. The video processing method of claim 15, further comprising:
storing as 3D priority viewer information face information of a viewer selected on a camera video; and
giving priority levels to the viewers on the basis of the stored 3D priority viewer information.
